(19) United States
(12) Patent Application Publication
(10) Pub. No.: US 2016/0006088 A1
(43) Pub. Date: Jan. 7, 2016

(54) BATTERY THERMAL MANAGEMENT FOR HYBRID ELECTRIC VEHICLES USING A PHASE-CHANGE MATERIAL COLD PLATE

(71) Applicant: Embry-Riddle Aeronautical University, Inc., Daytona Beach, FL (US)

(72) Inventors: Sandra Boetcher, Daytona Beach, FL (US); Marc Compere, Orlando, FL (US); Domenic Barsotti, Daytona Beach, FL (US); William Townsend Hyatt, Albuquerque, NM (US); Brian Neal Harries, Long Beach, CA (US)

(21) Appl. No.: 14/789,190

(22) Filed: Jul. 1, 2015

Related U.S. Application Data
(60) Provisional application No. 61/998,590, filed on Jul. 1, 2014.

(51) Int. Cl. H01M 10/6556; H01M 10/6567; H01M 10/635; H01M 10/625

(52) U.S. Cl. CPC H01M 10/6556; H01M 10/625; H01M 10/6567; H01M 10/635; H01M 2220/20

(57) ABSTRACT

A thermal management system for an energy storage device that includes a liquid-cooled cold plate made of phase-change material changeable from a substantially solid form to a substantially liquid form upon absorbing heat generated by the energy storage device. The system may be useful as a thermal management solution for energy storage systems (ESS) in hybrid-electric vehicles (HEV).

### PRIORITY

The present Patent Application is a formalization of previously filed, co-pending U.S. Provisional Patent Application Ser. No. 61/998,590 filed on Jul. 1, 2014, by the inventors named in the present Application. This Patent Application claims the benefit of the filing date of this cited Provisional Patent Application according to the statutes and rules governing provisional patent applications, particularly 35 U.S.C. §119(e), and 37 C.F.R. §§1.78(a)(3) and 1.78(a)(4). The specification and drawings of the Provisional Patent Application referenced above are specifically incorporated herein by reference as if set forth in their entirety.

### FIELD OF THE DISCLOSURE

The present disclosure relates to thermal management systems. In particular, the present disclosure relates to management of thermal outputs or heat produced by energy storage systems, such as batteries used on hybrid-electric vehicles.

### BACKGROUND

The need for larger energy storage systems (ESS) has increased as the demand for longer all-electric ranges (AER) in hybrid-electric vehicles (HEV) has grown with the increase in HEV's in recent years. An important design concern of large ESS's is the thermal management system (TMS) for managing heat generated by the battery systems powering such HEV's. There are two primary cooling strategies currently utilized by industry: air cooling and liquid cooling. Air cooling is advantageous because it is lightweight and simple. However, during high start-stop driving and relatively low speeds, large volumetric flow rates are required to properly cool the ESS in many HEV's. This drives the need for larger and/or more powerful fans, which typically add mass and consume more power. Liquid cooling is desirable because it occupies a smaller volume; however, because liquid cooling typically requires a metal cold plate (usually aluminum) and a liquid coolant, such systems generally are heavier compared to air cooling. Additionally, more pumping power is typically needed for a liquid-cooled system than for a passive air-cooled system.

A more recent alternative to utilizing air and liquid cooling for HEV battery thermal management involves the use of phase-change materials (PCMs). PCMs absorb and store energy while changing phase. Generally the phase-change material has been put in direct contact with the battery cells. However, because the thermal conductivity of pure PCMs is relatively low, their use has been limited in battery thermal management applications for HEV's.

### SUMMARY

The present disclosure generally relates to a thermal management system for management of thermal output or heat from electrical power storage devices or systems. In one embodiment, the thermal management system can have a cold plate whose body includes a conduit and at least partially comprises a phase-change material. The system may also include a cooling liquid and a pump. The pump can be configured and/or operated to selectively pump the cooling liquid through the conduit of the cold plate, for example based on a selected interval, temperature measurement(s), or other factors.

In some embodiments, the thermal management system of the present disclosure can be used to cool an energy storage system, such as the batteries of a hybrid electric vehicle. In addition, the thermal management system can be incorporated into or with the energy storage system, such as a battery, while in other embodiments, the thermal management system can be located external to the battery or other energy storage device or system.

The present disclosure also includes a method of controlling thermal management in an energy storage or battery system for hybrid electric vehicles. In one embodiment, the method comprises thermally coupling a cold plate to the battery system. The cold plate comprises a phase-change material. The method further includes intermittently pumping a cooling liquid through a conduit within the cold plate.

These and other aspects of the present invention will become apparent to those skilled in the art after a reading of the following description of the preferred embodiments, when considered in conjunction with the drawings. It should be understood that both the foregoing general description and the following detailed description are explanatory only and are not restrictive of the invention as claimed.

### BRIEF DESCRIPTION OF DRAWINGS

FIG. 1 illustrates an example of a phase-change material cold plate for use in accordance with embodiments of the present disclosure.

FIGS. 2A-2B are schematic illustrations of a thermal management system according to embodiments of the present disclosure.

FIG. 3 shows an example of a battery system incorporating the PCM cold plate of the present disclosure.

FIG. 4 is a graphical representation of measured temperature at the midpoint of the PCM cold plate as a function of time during cooling cycles.

FIG. 5 is a diagram of the on/off run cycle of a pump in a thermal management system of the present disclosure for various temperature inlet conditions.

FIG. 6 is a contour diagram of the temperature on the heat-flux side of the PCM cold plate at pump shut-off when Tinlet=15° C.

FIG. 7 is a contour diagram of the temperature on the heat-flux side of the PCM cold plate at pump shut-off when Tinlet=20° C.

FIG. 8 is a contour diagram of the temperature on the heat-flux side of the PCM cold plate at pump shut-off when Tinlet=25° C.

FIG. 9 is a contour diagram of the temperature on the heat-flux side of the PCM cold plate at pump shut-off when Tinlet=30° C.

It will be understood that the drawings accompanying the present disclosure, which are included to provide a further understanding of the present disclosure, are incorporated in and constitute a part of this specification, illustrate various aspects, features, advantages and benefits of the present disclosure and invention, and together with the following detailed description, serve to explain the principles of the present invention. In addition, those skilled in the art will understand that in practice, various features of the drawings discussed herein are not necessarily drawn to scale, and that dimensions of various features and elements shown or illustrated in the drawings and/or discussed in the following detailed description may be expanded, reduced, or moved to an exploded position, in order to more clearly illustrate the principles and embodiments of the present invention as set forth in this disclosure.

### DETAILED DESCRIPTION

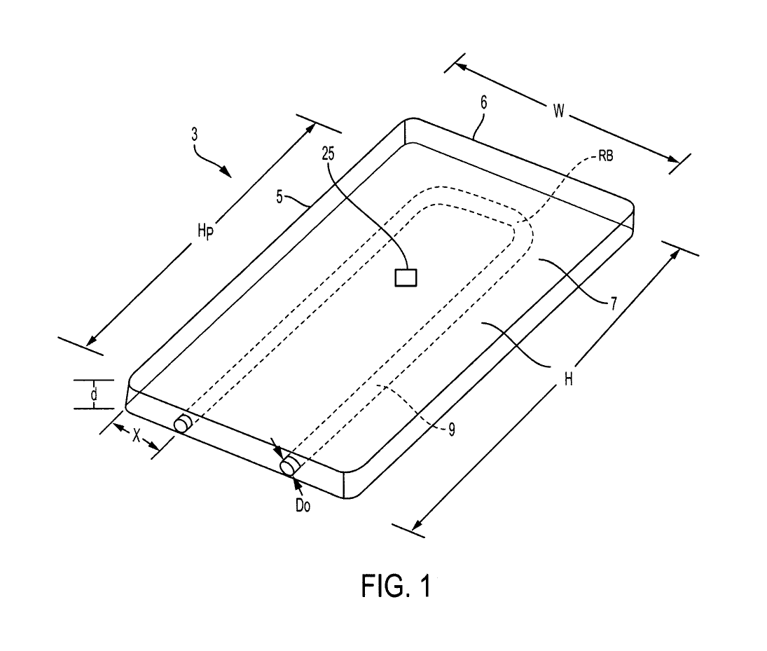

The current disclosure is directed to a thermal management system (TMS) 1 comprising a cold plate 3 that is liquid cooled, and which will be formed at least partially from a phase-change material (PCM) 7. FIG. 1 shows one example of a cold plate 3 for use in a thermal management system 1. The cold plate 3 may include a body 5 that can have an elongated plate-like shape, although other configurations are also possible as needed to fit a prescribed thermal management application. The body 5 of the cold plate 3 can be made from an open structure, e.g., a matrix 6, of graphite or other thermally conductive material, which matrix 6 may be impregnated with, embedded within, or provide encapsulation for a phase-change material 7 such that the phase-change material 7 may be substantially contained and/or constrained therewithin when in a liquid phase. In most embodiments, the phase-change material 7 is a solid/liquid phase-change material. For example, the phase-change material 7 may include a wax material, or can include other suitable phase-change materials. In a preferred embodiment, the body 5 may be formed from a graphite-matrix phase-change material. An example of a suitable graphite-matrix phase-change material may be PCC™ available from AllCell Technologies, LCC, Chicago, Ill.

A cooling liquid conduit 9 is defined through the body 5 of the cold plate 3 so that the cold plate 3 can be actively cooled. In one embodiment, a substantially u-shaped copper pipe can be used to form the conduit 9. Other materials, such as various metal alloys or other, similar materials having heat conductive properties that can be generally similar to that of copper, also can be used for the cooling liquid conduit. A cooling liquid, for example a 50-50 solution of ethylene glycol and water may be cycled through the cold plate 3 using the conduit 9 to provide a desired cooling or thermal/heat reduction. Other cooling liquids can be used, including solutions with ratios of water and ethylene glycol that are not a 50-50 blend.

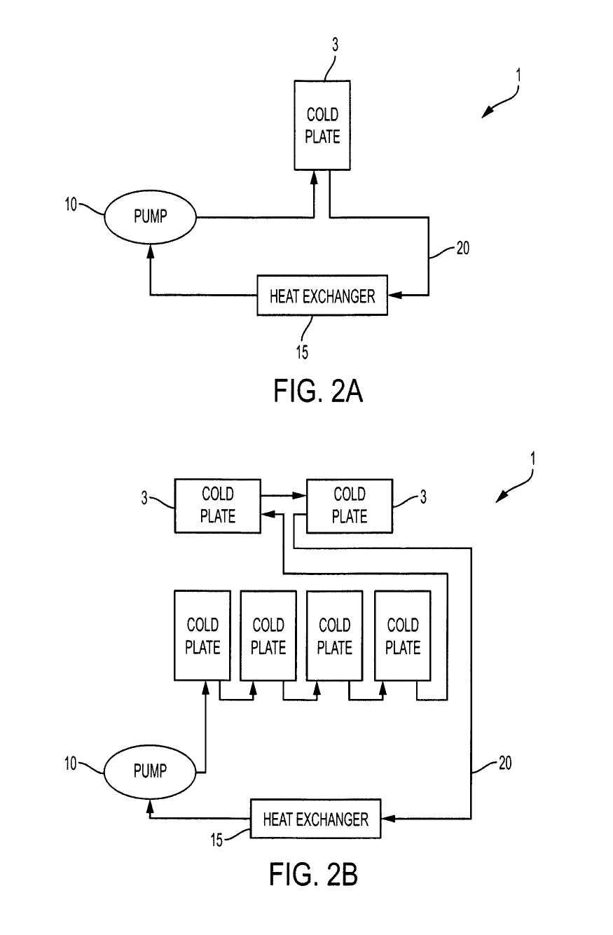

FIGS. 2A and 2B show embodiments of thermal management systems 1 according to the present disclosure. Each system 1 may include a cold plate 3 having a phase-change material 7 as discussed above. Each system 1 may also include a pump 10, a heat exchanger 15, and a substantially closed flow path 20 in fluid communication with the conduit 9 of the cold plate 3. The system 1 shown in FIG. 2A illustrates the movement of the cooling liquid as it is pumped around the flow path 20, where the cooling liquid is heated as it passes through the conduit 9 and cooled as it passes through the heat exchanger 15. FIG. 2B shows a second embodiment comprising a plurality of cold plates 3 in fluid communication with the flow path 20, where the flow path 20 connects the conduits 9 of each cold plate 3 in series. Such an arrangement can be used to spread heat loads across a series of cold plates 3, with the number of cold plates 3 used being variable depending on projected heat loads or capacity required for the thermal management system 1.

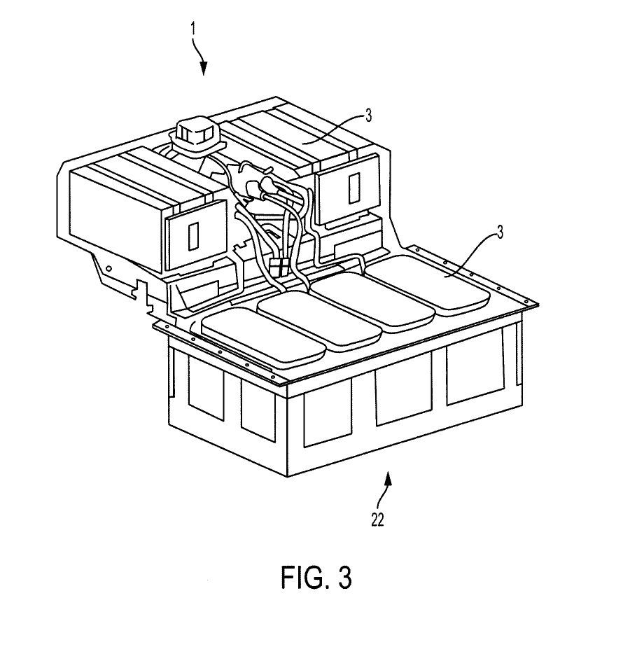

FIG. 3 shows an example of a battery 22 on which the thermal management system 1 is externally mounted for heat dissipation.

In some embodiments, each cold plate 3 can be provided with a sensor 25, such as a temperature sensor (see FIG. 1) or similar monitoring device. The sensor 25 may be centered on the body 5 of the cold plate 3 to determine a midpoint temperature of the body 5. The sensor 25 includes, or communicates with, electronics configured to vary the operating characteristics of the pump 10. The pump 10 further may be configured to be turned on and off in response to communications from the sensor, or, in other embodiments, can be operated/engaged at predetermined time intervals or in response to other measured parameters, with the sensor further providing an override control aspect to engage or disengage the pump as needed to provide a consistent cooling as energy usage increases or decreases. In other embodiments, the pump 10 may have a variable flow rate.

In one example, the pump 10 (i.e., the active cooling component of the system 1 when used with the cooling liquid) can be maintained in an off or idle state at temperatures or conditions below a predetermined threshold, and the pump 10 is activated or turned on at temperatures or conditions above a predetermined threshold. For example, the phase-change material 7 will begin to melt at approximately a known melting temperature for a given material. Heat is being stored by the phase-change material as it melts. During this melting stage, the temperature of the material can stay substantially the same. Once the phase-change material is completely melted (i.e., thermally saturated) the temperature of the PCM will begin to rise. The reverse is true as the phase-change material cools. The temperature remains substantially steady as the material solidifies and begins to fall again once the phase-change material has substantially fully solidified. Therefore, in one example, the pump 10 may be activated when the sensor 25 determines that the phase-change material is thermally saturated, and the pump 10 may be turned off when the sensor 25 determines that the phase-change material is substantially fully solidified.

As a result, by utilizing the PCM heat storage capabilities with controlled liquid cooling of the cold plate, upon thermal saturation or other monitored set-point, such as based on monitored temperatures thereof, less pump run time is required. The pump supplying the cooling liquid can be operated intermittently, rather than continuously, as with a traditional metal (aluminum) cold plate. Liquid cooling the cold plate allows a design without requiring the TMS to necessarily be designed for a substantial maximum projected thermal capacity (i.e., potentially being designed with too much capacity) as required for TMS' using PCMs exclusively.

The disclosed thermal management system 1 further can be provided with a reduced profile and/or weight through the use of phase-change materials having a lower density compared with traditional cold plate materials like aluminum. Therefore, with a similar size cold plate, a thermal management system with a PCM cold plate may weigh less. For example, the density of PCC™ by AllCell is approximately ⅔ less than aluminum, but does not require additional material to provide similar results.

Additionally, because phase-change materials store heat, the heat spikes seen in batteries during drive cycles of hybrid electric vehicles can be absorbed and effectively filtered. This allows the liquid cooling components to be sized for the average heat rejection rate of the energy storage system rather than for maximum instantaneous heat flux peaks, which may occur frequently during a drive cycle, and enables the thermal management system 1 to rely more heavily upon passive cooling from the cold plate itself.

Also, unlike traditional active cooling systems that generally require continuous pumping of the cooling fluid, the disclosed thermal management system 1 can use only intermittent pumping to save energy costs. The liquid cooling pump requirements are reduced in both intensity and duration because of the phase-change material's ability to absorb heat. This heat storage increases the time over which a thermal management system may remove heat and allows the pump and conduits to be sized for the average heat rejection rate rather than for the peaks.

Still further, the disclosed system does not require inserting a phase-change material into the interstitial spaces between individual battery cells. Instead, the thermal conductivity of the phase-change material can be increased by the combination with a heat conductive matrix, such as graphite, so that the phase-change material can be sufficiently efficient to operate external to the battery cells.

### EXAMPLE

A graphite matrix-PCM cold plate consistent with FIG. 1 was evaluated. The dimensions of the PCM cold plate with liquid cooling and cooling liquid conduit thereof, as used in the tests, are given in Table 1 below. For example, in the present embodiment, the outside diameter of the copper pipe is given as “Do” and the thickness of the copper pipe is 0.035 in. (0.089 cm). It will be understood that other size/thickness pipes, and other conduit materials also can be used. The dimensions of the cold plate are not limited to the example given. The material for the cold plate according to this example was PCC™ from AllCell Technologies.

TABLE 1
Dimensions of the cold plate assembly.

| H | 13.750 in. | (34.925 cm) |
|---|---|---|
| W | 6.500 | (16.510) |
| d | 0.625 | (1.588) |
| Do | 0.375 | (0.952) |
| Hp | 12.000 | (30.480) |
| X | 1.750 | (4.445) |
| RB | 1.000 | (2.540) |

The material properties of the solids, PCM, copper, and aluminum, are summarized in Table 2 below. The temperature range of melting for the PCM is between 34.5 and 39.5° C. The enthalpy based on mass as a function of temperature that was used in the simulation is shown in Table 3 below.

TABLE 2
Material properties of the PCM and the aluminum.

| | PCM | Copper | Aluminum |
|---|---|---|---|
| Density ρ. kg/m³ | 925 | 8940 | 2702 |
| Specific Heat Capacity cₚ, J/kg · K | 1800 | 386 | 903 |
| Thermal Conductivity k, W/m · K | 25 | 398 | 237 |
| Melting Point, ° C. | 34.5 | — | — |
| Melting Range, ° C. | 5 | — | — |
| Latent Heat of Fusion h_{fs}, J/kg | 174000 | — | — |

TABLE 3
Enthalpy versus temperature of the PCM.

| Temperature (° C.) | Enthalpy (J/kg) |
|---|---|
| 1 | 0 |
| 34.5 | 60300 |
| 39.5 | 183000 |
| 300 | 468900 |

The liquid cooling system is actively controlled by sensing the midpoint temperature of the PCM cold plate and then engaging the fluid flow at a specified set-point temperature. FIG. 1 shows an example placement of a temperature sensor 25 along the cold plate 3. The set-point used in the current simulation is 39.5° C. When the temperature set-point is achieved, the liquid cooling system (all velocities initially at zero) is turned on and the following velocity boundary condition is applied at the inlet of the pipe:

Uᵢₙₗₑₜ=0.6 m/s (1)

Furthermore, the inlet temperature (“Tinlet”) of the liquid is parametrically varied.

15° C.<Tᵢₙₗₑₜ<30° C. (2)

When the midpoint temperature of the PCM reaches 34.5° C., which is the beginning of the phase-change, the liquid cooling system is turned off by reapplying a zero velocity at the inlet of the pipe.

The standard outlet boundary condition of a zero axial velocity gradient and zero gage pressure are applied at the outlet of the pipe.

In order to determine the thermal load of the Li-ion battery, an ESS (battery) plant model was developed and simulated using a two drive-cycle blend of the Federal Test Procedure 75 (FTP75) and Highway Fuel Economy Test (HWFET), with a multiplier of two on the battery current. The electrical current data is calculated for a vehicle that is running in charge-depleting (CD) mode. This is an operational mode where all tractive power is drawn from the ESS and is considered the worst-case scenario.

Because the heat generated by the chemical reactions inside of the battery is negligible, only the heat generated by the internal resistance is considered. From the electrical current determined by the drive cycle, the heat flux is:

$$\frac{{q}^{″} = {l}^{2} R}{{A}_{c}} \qquad ( 3 )$$

In this equation, I is the electrical current, R is the internal resistance, and Ac is the area of the cooling surfaces. Only three of the battery's six sides reject heat; therefore, Ac is the surface area of three sides of the battery. For proof-of-concept and preliminary results, the root-mean square (RMS) value of the heat flux calculated from the drive cycle is applied as the thermal load.

Where the cold plate meets the battery, an RMS-heat flux is applied

q′=511 W/m² (4)

Around all other sides of the simulated cold plate, adiabatic boundary conditions are imposed.

The initial temperature of the simulated cold plate is set to 30° C.

### Results

In numerical simulation testing to examine the effectiveness of the proposed PCM cold plate design structure and fluid mixture in absorbing heat, and the requirements for activating liquid cooling, heat transfer loads were calculated and extracted from simulations of combined test drive cycles using the Federal Test Procedure (FTP) and the Highway Fuel Economy Test (HWFET). For the preliminary study, the inlet temperature of the cooling liquid was parametrically varied between 15 and 30° C. The observed results were compared with a standard aluminum cold plate with an inlet temperature of 30° C.

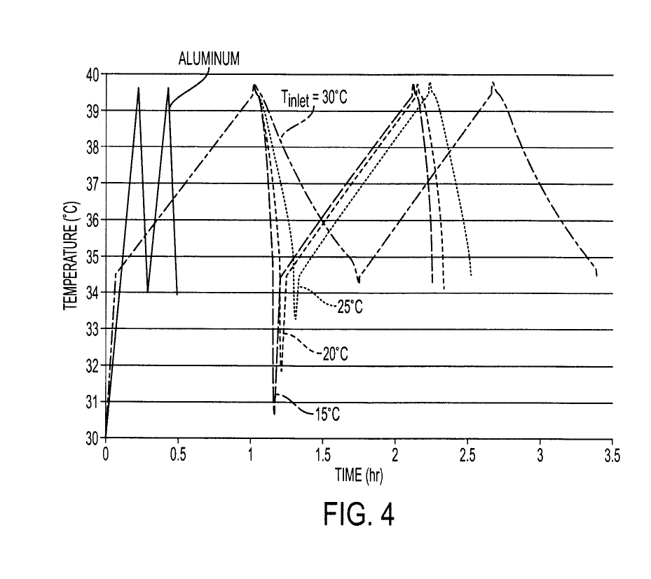

Two consecutive melting/solidification cycles were simulated and it is expected that the behavior of the system will become periodic. A graph of the midpoint temperature taken at the mid-plane of the cold plate, versus time for various inlet conditions is plotted in FIG. 4. In addition, the aluminum cold plate control, with a Tᵢₙₗₑₜ=30° C., is also plotted in the figure for comparison purposes. As can be seen in FIG. 4, the temperature versus time is equal for all PCM cases up until the initial melting of the PCM is complete at 39.5° C. The graph shows that it takes about one hour for the tested PCM to become thermally saturated. At this point, the pump was turned on to remove the heat stored in the PCM.

For the four inlet temperatures (15, 20, 25, and 30° C.), the temperature of the PCM promptly decreases when the pump is activated. As expected, the lowest inlet temperature removes heat from the PCM fastest. In fact, the temperature overshoots about 4° C. below the PCM melt-point of 34.5° C. even though the pump turns off at 34.5° C. For a coolant inlet temperature of 30° C., the midpoint temperature overshoots 34.5° C. by about 0.2° C. Therefore, in some embodiments, it may be desirable to turn off the pump 10 prior to complete solidification of the PCM.

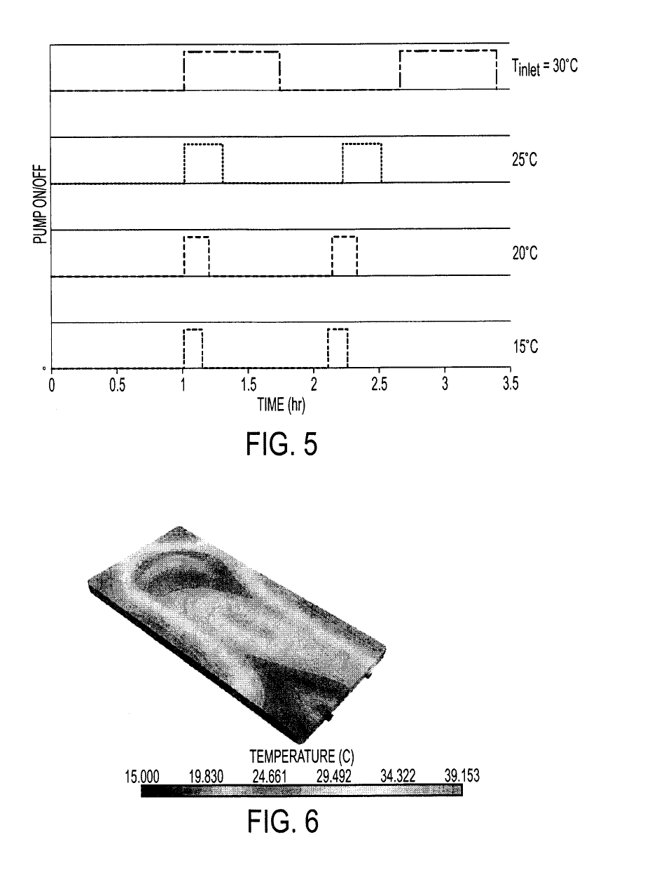

The timing of the pump cycling on and off is shown in FIG. 5. In FIG. 5, the pump turns on for all inlet temperature cases when the midpoint temperature reaches 39.5° C., which takes approximately one hour. For Tᵢₙₗₑₜ=15, 20, 25, and 30° C. the pump running time is 8.6, 11.5, 17.6 and 43.8 minutes, respectively to return the midpoint temperature to 34.5° C. The time it takes for the PCM to melt again after the pump has shut off is 57.5, 56.5, 55.2, and 55.1 minutes for Tᵢₙₗₑₜ=15, 20, 25, and 30° C., respectively. As can be seen here, because the difference between the re-melt times for all of the different pump inlet temperatures is less than one minute, there does not appear to be an appreciable advantage to cooling the PCM past its solidification temperature of 34.5° C.

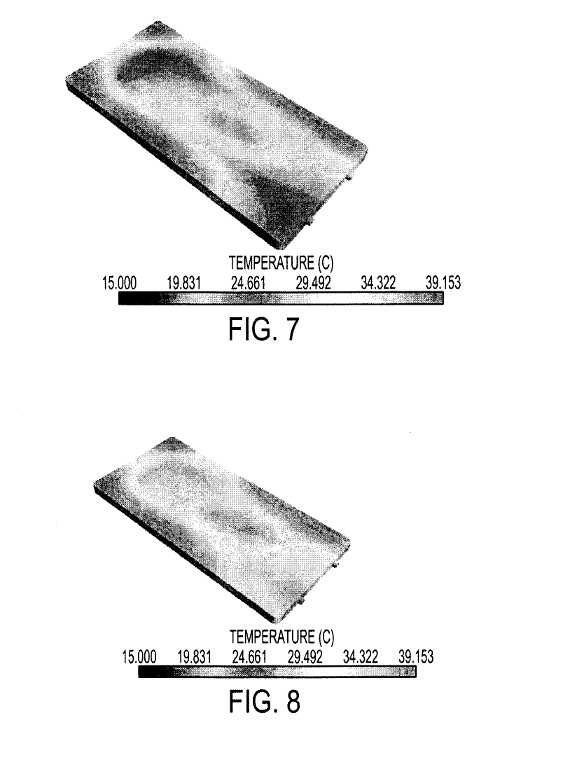

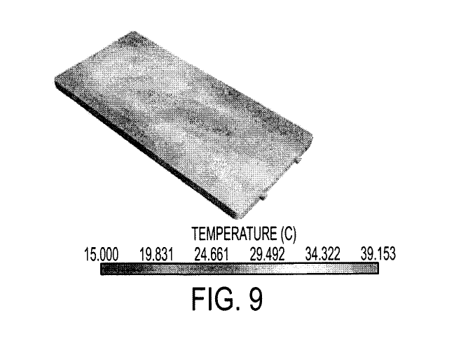

FIGS. 6-9 show the simulated temperature distribution along the surface of the cold plate 3 where the heat flux is applied when the pump shuts off. FIGS. 6-9 show the cases where Tᵢₙₗₑₜ=15, 20, 25, and 30° C. respectively.

To conclude, this disclosure presents a novel cold plate design for cooling HEV battery modules (such as shown in FIG. 3). The designed liquid-cooled PCM cold plate is lighter than traditional cold plates, has reduced continuous pumping requirements, and does not require inserting PCM into the interstitial spaces between individual battery cells. The composite cold plate with PCM material is approximately ⅓ the weight of a standard cold plate without a corresponding loss in thermal capacity. The PCM selected has thermal conductivity sufficient to remove heat from a single side of the battery module which is another convenient design feature.

The disclosed system provides effective thermal management with intermittent pump operation. The liquid cooling pump requirements are reduced in both intensity and duration because of the PCM's ability to absorb heat. This heat storage increases the time over which a thermal management system may remove heat, and allows the coolant pump to be sized for the average heat rejection rate rather than for the peaks.

The foregoing description generally illustrates and describes various embodiments of the present invention. It will, however, be understood by those skilled in the art that various changes and modifications can be made to the above-discussed construction of the present invention without departing from the spirit and scope of the invention as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present invention. Accordingly, various features and characteristics of the present invention as discussed herein may be selectively interchanged and applied to other illustrated and non-illustrated embodiments of the invention, and numerous variations, modifications, and additions further can be made thereto without departing from the spirit and scope of the present invention as set forth in the appended claims.

1. A thermal management system for an energy storage device, comprising:
a cold plate having a body with a conduit defined therein, wherein the body comprises a phase-change material changeable from a substantially solid form to a substantially liquid form upon absorbing heat generated by the energy storage device;
a cooling liquid; and
a pump,
wherein the pump selectively pumps the cooling liquid through the conduit of the cold plate for a duration sufficient to cool the phase-change material from its substantially liquid form to its substantially solid form for dissipation of heat absorbed thereby.

2. The thermal management system according to claim 1, wherein the body further comprises a graphite matrix.

3. The thermal management system according to claim 1, wherein the phase-change material comprises a wax material.

4. The thermal management system according to claim 1, wherein the cooling liquid comprises a solution of ethylene glycol and water.

5. The thermal management system according to claim 4, wherein the cooling liquid further comprises a 50/50 mixture of ethylene glycol and water.

6. The thermal management system according to claim 1, wherein the conduit comprises a copper pipe.

7. The thermal management system according to claim 1, further comprising a temperature sensor configured to engage the pump for pumping the cooling fluid through the cooling plate upon detection of a temperature indicative of the phase-change material becoming substantially thermally saturated.

8. The thermal management system according to claim 7, wherein pumping of the cooling liquid is substantially discontinued when the temperature sensor detects a solidification temperature of the phase-change material.

9. The thermal management system according to claim 7, wherein the temperature sensor is substantially centered with respect to the cold plate.

10. The thermal management system according to claim 1, further comprising a heat exchanger to cool the cooling liquid outside of the cold plate.

11. The thermal management system according to claim 1, further comprising a plurality of cold plates serially coupled in fluid communication.

12. An energy storage system having a thermal management system according to claim 1.

13. The energy storage system according to claim 12, comprising batteries for hybrid electric vehicles, and wherein the thermal management system is external to the batteries.

14. A method of controlling thermal management in a battery system for hybrid electric vehicles, comprising:
thermally coupling a cold plate to the battery system, the cold plate comprising a phase-change material;
absorbing heat generated by the battery system, whereupon the phase-change material changes from a solid to a liquid;
pumping a cooling liquid through the cold plate when the phase-change material becomes substantially saturated;
dissipating heat from the phase-change material to the cooling liquid as the phase-change material changes from the liquid to the solid.

15. The method of claim 14, where the phase-change material comprises a wax material and the cold plate further comprises a graphite material.

16. The method of claim 14, wherein the cooling liquid comprises a solution of ethylene glycol and water.

17. The method of claim 14, further comprising monitoring temperature the phase-change material, and upon detection of a setpoint temperature indicative of the phase-change material becoming substantially thermally saturated, initiating pumping of the cooling fluid through the cold plate.

18. The method of claim 17, further comprising substantially stopping pumping of the cooling fluid through the cooling plate upon detecting a temperature of the phase-change material indicative of the phase-change material becoming substantially fully solidified.

19. A thermal management system, comprising:
passive cooling means; and
active cooling means.

20. The thermal management system of claim 19, wherein:
the passive cooling means comprises a cold plate comprising a graphite matrix impregnated with wax; and
the active cooling means comprises intermittent pumping of a 50/50 solution of ethylene glycol and water through the cold plate.
